(19) United States
(12) Patent Application Publication
(10) Pub. No.: US 2006/0225362 A1
(43) Pub. Date: Oct. 12, 2006

(54) Tilt-latch assembly for a sash window

(76) Inventors: Dean Pettit, St. John, IN (US); Mark Eenigenburg, Lansing, IL (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 11/390,684

(22) Filed: Mar. 28, 2006

Related U.S. Application Data
(63) Continuation-in-part of application No. 11/376,723, filed on Mar. 15, 2006.
Application No. 11/376,723 is a continuation-in-part of application No. 11/296,854, filed on Dec. 7, 2005.
(60) Provisional application No. 60/665,770, filed on Mar. 28, 2005.

(51) Int. Cl. E05D 15/22

(52) U.S. Cl. 49/445; 49/184

(57) ABSTRACT

A tilt-latch structure or assembly (10) is used in a window assembly (11). The window assembly (11) has a sash window (12) slidable within a master frame (14) between a pair of guide rails (16), each guide rail (16) forming a shoe channel (17). A block and tackle balance assembly (70) is mounted in the shoe channel (17). The block and tackle balance assembly (70) includes a retainer (41) affixed thereto. The retainer (41) includes a projection (102). A tilt-latch (40) having a housing (42) is supported by the sash window (12) and includes an outward end opening (53). The tilt-latch (40) also includes a latch bolt (46) slidably retained within the housing (42) and having a distal end (60). The latch bolt (46) is slidable between an extended position and a retracted position. The distal end (60) has an aperture (62). When the sash window (12) is in a closed position, the aperture (62) of the latch bolt (46) receives the projection (102) of the retainer (41).

### RELATED APPLICATIONS

The present application claims priority to and the benefit of U.S. Provisional Application No. 60/665,770, filed on Mar. 28, 2005, and this application is further a continuation-in-part application of co-pending U.S. patent application Ser. No. 11/376,723, filed on Mar. 15, 2006, which is a continuation-in-part application of co-pending U.S. patent application Ser. No. 11/296,854, filed on Dec. 7, 2005, which applications are incorporated by reference and made a part hereof.

### TECHNICAL FIELD

The invention relates to window hardware for windows slidable within a master frame, more specifically, it is related to a tilt-latch structure for a sash window.

### BACKGROUND OF THE INVENTION

A pivotal sash window adapted for installation in a master frame of a sash window assembly is well known. The sash window is slidable within the master frame. The sash window uses a balance system to facilitate opening and closing of the sash window. One such balance system utilizes a block and tackle balance assembly. Typically, tilt-latches are installed on or in the sash window and, along with other cooperating hardware, allow the sash window to be pivoted from the frame. One example of such a tilt-latch is shown in U.S. Pat. No. 6,155,615. In some sash window assemblies, excessive wind loads can cause certain tilt-latches to become disengaged from the master frame allowing unwanted pivoting and disengagement of the sash window from the master frame. This can result in damage to the window assembly and injury. While tilt-latches according to the prior art provide a number of advantageous features, they nevertheless have certain limitations.

The present invention is provided to solve the problems discussed above and other problems, and to provide advantages and aspects not provided by prior tilt-latches of this type. A full discussion of the features and advantages of the present invention is deferred to the following detailed description, which proceeds with reference to the accompanying drawings.

### SUMMARY OF THE INVENTION

A tilt-latch assembly, which may at times may also be referred to as a tilt-latch structure, is provided for a sash window assembly. The tilt-latch assembly has cooperative structure that resists loads on the sash window assembly to minimize or prevent unwanted sash window disengagement from the master frame. In one preferred embodiment of the invention, the cooperative structure is located between a tilt-latch and balance assembly associated with the sash window assembly.

A tilt-latch assembly is provided for use with a window assembly having a sash window slidable within a master frame between a pair of guide rails. Each guide rail forms a shoe channel having a block and tackle balance assembly positioned within the shoe channel. The tilt-latch assembly includes a retainer with a raised projection. The retainer is affixed to the block and tackle balance assembly. The tilt-latch has a housing supported by the sash window and has an outward end opening. A latch bolt is slidably retained within the housing. The latch bolt has a distal end. The latch bolt is also slidable between an extended position and a retracted position, and the distal end has an aperture to receive the projection.

According to another aspect of the invention, a retainer is provided for use with a window assembly having a sash window slidable within a master frame between a pair of guide rails. Each of the guide rail forms a shoe channel and a block and tackle balance assembly is positioned within each shoe channel. The retainer has a mating assembly that is configured to connect with the block and tackle balance assembly. A pulley mount is preferably integrally formed with the mating assembly. A peg extends from the mating assembly.

According to another aspect of the invention, a block and tackle balance assembly is provided for use with a window assembly having a sash window slidable within a master frame between a pair of guide rails. Each guide rail forms a shoe channel in which the block and tackle balance assembly is positioned. The block and tackle balance assembly includes an elongated balance channel. Inside the balance channel is a block and tackle mechanism including pulleys, a spring and a cord. A tilt-latch retainer is also positioned within the balance channel.

According to another aspect of the invention, a latch bolt is provided for use in a tilt-latch for a window assembly having a sash window slidable within a master frame between a pair of guide rails. Each guide rail forms a shoe channel, and a block and tackle balance assembly having a retainer is mounted within the shoe channel. The latch bolt has a body with a proximal end and a distal end. The distal end of the body has an aperture for cooperative engagement with the retainer.

According to another aspect of the invention, a tilt-latch is provided for use in a window assembly having a sash window slidable within a master frame between a pair of guide rails. Each guide rail forms a shoe channel. A block and tackle balance assembly is mounted within the shoe channel. A retainer has a projection and is mounted to the block and tackle balance assembly. The tilt-latch includes a housing supported by the sash window and with an outward end opening. The tilt-latch also includes a slidable latch bolt with a distal end. The latch bolt is slidable between an extended position and a retracted position. The distal end has an aperture that receives the projection of the retainer.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a sash window assembly;

FIG. 2 is a partial front view of a mounted block and tackle balance assembly having a retainer according to the present invention;

FIG. 3 is a partial perspective view of a block and tackle balance assembly including the retainer as shown in FIG. 2;

FIG. 4 is a perspective view of the retainer of the present invention;

FIG. 5 is another perspective view of the retainer of FIG. 4;

FIG. 6 is a top view of the retainer of FIG. 4;

FIG. 7 is a side view of the retainer of FIG. 4;

FIG. 8 is a front view of the retainer of FIG. 4;

FIG. 9 is another side view of the retainer of FIG. 4;

FIG. 10 is a bottom view of the retainer of FIG. 4;

FIG. 11 is a top view of a tilt-latch housing of the present invention;

FIG. 12 is a bottom view of the tilt-latch housing of FIG. 11;

FIG. 13 is a perspective view of a latch bolt of the tilt-latch of the present invention;

FIG. 14 is a perspective view of another retainer of the present invention;

FIG. 15 is a top view of the retainer of FIG. 14;

FIG. 16 is a side view of the retainer of FIG. 14;

FIG. 17 is a front view of the retainer of FIG. 14;

FIG. 18 is another side view of the retainer of FIG. 14;

FIG. 19 is a partial schematic top view of the tilt-latch assembly of the present invention installed in the window assembly of FIG. 1;

FIG. 20 is a partial schematic side view of the tilt-latch assembly of FIG. 19; and,

FIG. 21 is a partial schematic side view of another embodiment of the tilt-latch assembly of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

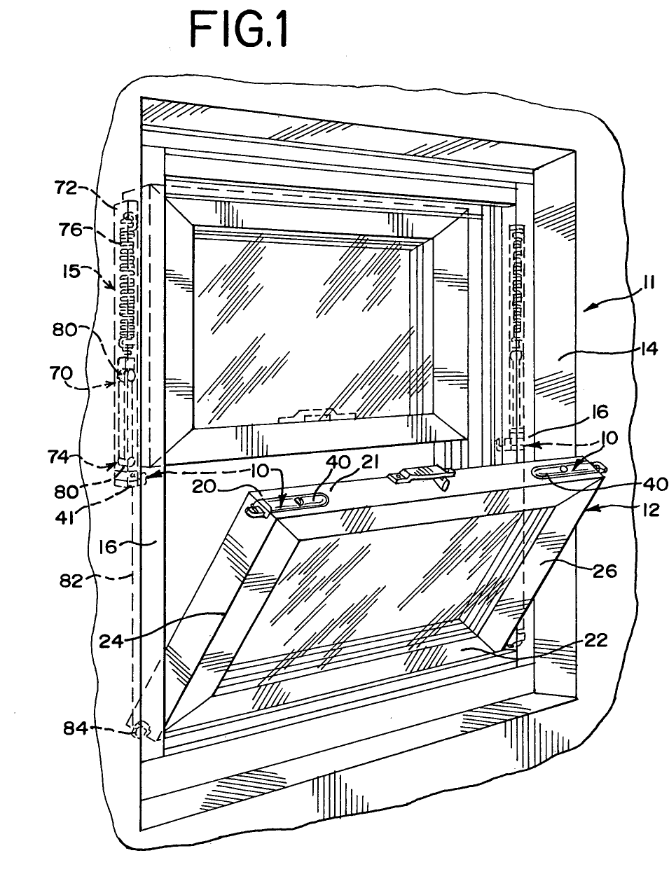

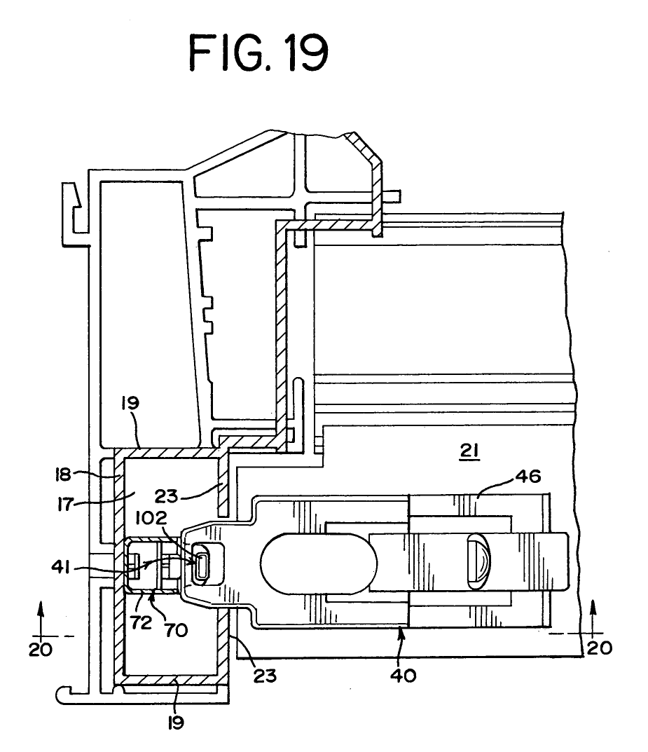

FIG. 1 shows a tilt-latch assembly, or tilt-latch structure, of the present invention, generally designated with the reference numeral 10, used in a sash window assembly 11. The sash window assembly 11 shown in FIG. 1 is a double-hung window assembly having a pivotal sash window 12 installed in a master frame 14. The particular sash window assembly 11 shown in FIG. 1 is made from extruded vinyl although it could also be made from other materials including wood. The tilt-latch assembly 10 could also be used in all types of pivotal windows or structures. The sash window 12 is pivotally mounted to the master frame 14 by a brake shoe assembly 84. As is well known, the master frame 14 has opposed, vertically extending guide rails 16 that form a shoe channel 17. As shown in FIG. 19, the shoe channel 17 includes a channel base 18, a pair of channel sidewalls 19 extending from the base 18, and a pair of shoulders 23 extending inward from the sidewalls 19. As further shown in FIG. 1, the sash window 12 has a top sash rail 20 having a top surface 21, a base 22 and a pair of stiles 24, 26, cooperatively connected together at adjacent extremities thereof to form a sash frame, typically rectangular although other shapes are possible. A balance assembly 15 is typically positioned within the shoe channel 17 and is operably connected between the master frame 14 and the sash window 12, preferably via the brake shoe 84. A portion of the tilt-latch assembly 10 is typically mounted to the top surface 21 of the top sash rail 20.

As shown in FIGS. 1, 19 and 20, the tilt-latch assembly 10 generally comprises a tilt-latch 40 and a retainer 41. As previously discussed, the tilt-latch 40 is mounted in the top sash rail 20 of the sash window 12. The retainer 41 is positioned within the shoe channel 17 and is generally connected to the balance assembly 15. As will be discussed in greater detail below, the tilt-latch 40 and the retainer 41 have cooperative structure to enhance the overall operation of the sash window assembly 11.

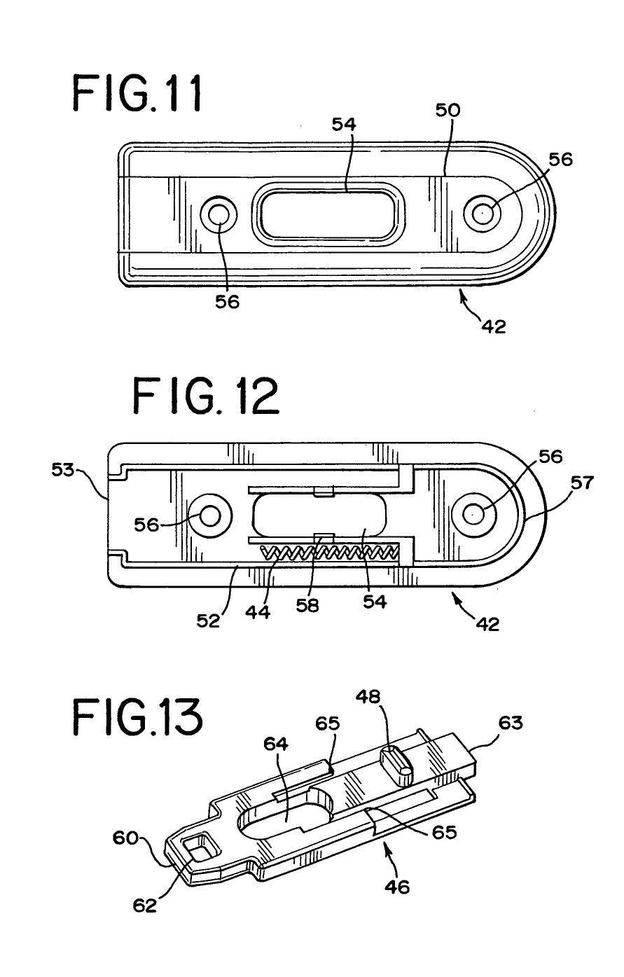

As shown in FIGS. 11-13 and 19-20, the tilt-latch 40 comprises a housing 42, a biasing spring 44 (shown schematically in FIG. 12), a latch bolt 46, and an actuator 48. The housing 42 is adapted to be supported by the top rail 20. The latch bolt 46 is disposed within the housing 42. The actuator 48 is connected to the latch bolt 46 and is designed to allow a user to retract the latch bolt 46 into the housing 42 against the biasing force of the spring 44. As shown, the actuator 48 is shown integrally formed with the latch bolt 46. However, it is understood that the actuator 48 may be a separate component of the tilt-latch 40 and attached to the latch bolt 46 by any of various means.

As shown in FIGS. 11 and 12, the preferred housing 42 is of a top mount construction, although other configurations are possible, and includes a top wall 50 and two depending side walls 52 that define an outward end opening 53. The side walls 52 generally curve and meet to define a closed end 57. The top wall 50 includes a slot 54 and a pair of screw holes 56. Also depending from the top wall 50 is a pair of latch slides 58. While the top mount construction shown in FIGS. 11 and 12 is one preferred embodiment, the tilt-latch housing 42 may have other constructions. For example, the housing 42 may be substantially similar in structure to the housing in U.S. Pat. No. 5,139,291, which is incorporated by reference herein. The housing is designed to be substantially flush-mounted in the top rail 20 wherein the housing has a groove in each side rail that accepts a header rail of the top sash rail to secure the tilt-latch within the top sash rail 20.

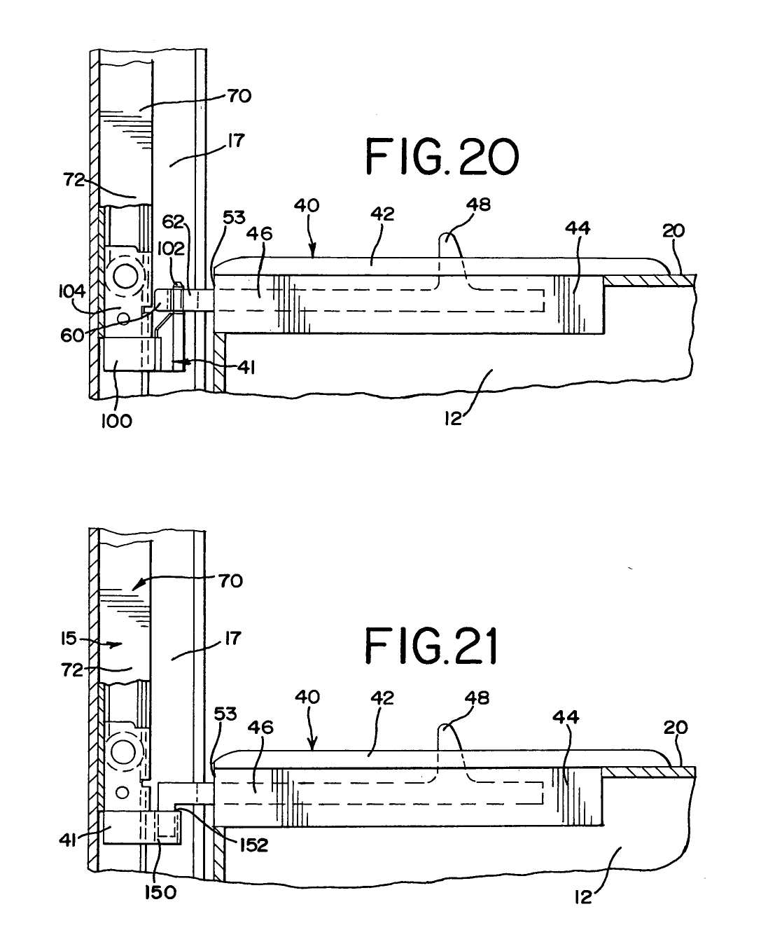

As shown in FIGS. 13, 19, and 20, the latch bolt 46 is adapted to be slidably retained by the housing 42. The latch bolt 46 has an extended position (FIGS. 19-20) and a retracted position. The latch bolt 46 generally has cooperative structure thereon, which cooperatively engages with cooperative structure 41 on the balance assembly 15 when the sash window 12 is in the closed position and the latch bolt 46 is in the extended position. The latch bolt 46 shown in FIG. 13 includes a distal end 60 having an aperture 62 and a proximal end 63 opposed from the distal end 60. The distal end 60 is relatively far from the closed end 57 of the housing 42, and the proximal end 63 is relatively close to the closed end 57 of the housing 42 when the latch bolt 46 is positioned within the housing 42. The distal end 60 is preferably tapered. The aperture 62 extends vertically through the latch bolt 46. While in a preferred embodiment the aperture 62 extends completely through the latch bolt 46, the aperture 62 could extend through a portion of the latch bolt 46. For example, the distal end 60 could be hollowed-out on one side of the latch bolt 46. The aperture 62 shown in FIG. 13 is generally rectangular. It is understood that other shapes can be used including circular, square, oval, oblong etc. Located between the distal end 60 and the proximal end 63 are the actuator 48 and a screw slot 64. The screw slot is generally elongated to allow sliding of the latch bolt 46 around a screw (not shown) or other fastener.

As further shown in FIG. 13 the latch bolt 46 includes a pair of latch slots 65. The latch slots 65 receive the latch slides 58 of the housing 42. The latch bolt 46 and housing 42 cooperate to allow relative sliding movement between the latch bolt 46 and housing 42. The latch bolt 46 and housing are preferably symmetric along their respective central axes.

To assemble the tilt-latch 40, the latch bolt 46 is inserted into the housing 42 such that the distal end 60 extends through the outward end opening 53, the screw slot 64 aligns with one of the screw holes of the top wall 50, and the actuator 48 extends through the top wall slot 54 of the housing 42. The latch slides 58 snappingly and slidingly engage the latch bolt 46. The latch bolt 46 is then slidable between an extended position wherein the distal end 60 extends through the outward end opening 53 and a retracted position wherein the distal end 60 retracts towards the housing 42, such as for pivoting the sash window 12. Also, the spring 44 or other resilient member is preferably positioned between the latch bolt 46 and the housing 42 to bias the latch bolt 46 towards its extended position.

The assembled tilt-latch 40 is attached to the top surface 21 of the top sash rail 20, such as by screws or other fasteners inserted through the screw holes 56 of the top wall 50 of the housing 42. Before doing so, the tilt-latch 40 is positioned as generally shown in FIG. 1. As discussed, it is understood that other mounting structures could be incorporated on the housing 42. For example, flush mount structures could be employed wherein the structure would cooperate with the top rail structure eliminating the need for separate screw fasteners through screw holes 56, such as in U.S. Pat. No. 5,139,291. In such case, the housing 42 would have a groove in each side wall that accepts a header rail of the top sash rail to secure the tilt-latch 40 within the top sash rail 20.

As shown in FIGS. 1-3 and 20, the balance assembly 15 is connected between the master frame 14 and the sash window 12 to provide an upward biasing force to the sash window. The balance assembly 15 is in one preferred embodiment, a block and tackle balance assembly 70. The block and tackle balance assembly 70 is positioned within the shoe channel 17 and counterbalances the sash window 12. As shown in FIGS. 1-3, the block and tackle balance assembly 70 generally includes a balance channel 72 having a block and tackle mechanism 74 therein. It is recognized that block and tackle balance assemblies 70 are known in the art, such as disclosed in U.S. Pat. No. 6,622,342, which is incorporated by reference herein. It is further understood that the block and tackle balance 70 of the present invention has all of the similar components of the block and tackle balance assembly of U.S. Pat. No. 6,622,342. The block and tackle balance assembly 70 of the present invention, however, has an inverted configuration from the assembly in U.S. Pat. No. 6,622,342. Thus, the balance channel 72 is mounted to the shoe channel 17 and an end of the block and tackle mechanism, e.g. a cord as described below, is connected to the sash window 12 typically via the brake shoe 84.

As further shown in FIGS. 1-3, the balance channel 72 has a generally C-shaped cross-section and houses the block and tackle mechanism 74. The balance channel 72 has a set of openings 73 and a distal edge 75 for cooperation with the retainer 41 as described in greater detail below.

As also shown in FIGS. 1-3, the block and tackle mechanism 74 of the block and tackle assembly 70 generally includes sets of pulleys 80, an extension spring 76 and a cord 82. The pulleys 80, spring 76 and cord 82 are operably mounted in the balance channel 72 as is known. The cord 82 has one end connected within the balance channel 72, is wound around the pulleys 80 and has another end connected to the brake shoe 84. Thus, the block and tackle balance assembly 70 provides an upward biasing force to the sash window 12. As described in greater detail below, the retainer 41 is incorporated with the block and tackle balance assembly 70. In particular, the retainer 41 is connected with a first set of pulleys 80 in the balance channel 72.

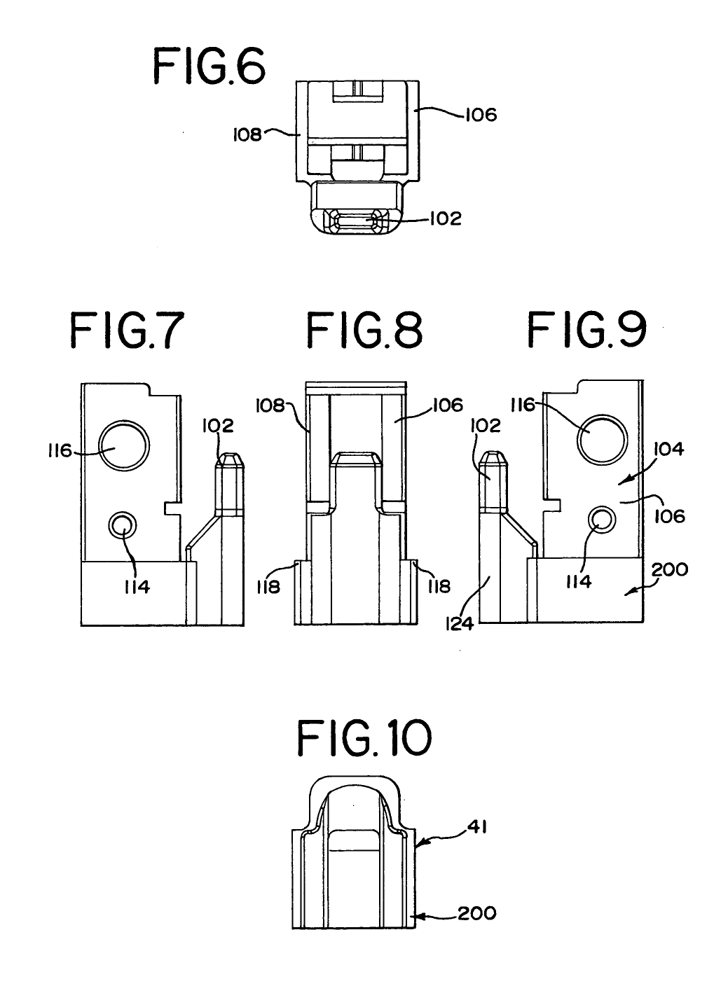

As shown in FIGS. 2-10, the retainer 41 generally includes a base 100 and a projection 102 extending from the base 100. As will be discussed in greater detail below, the projection 102 of the retainer 41 forms a portion of the cooperative structure. In particular, the projection 102, while being operably connected to the balance assembly 15, cooperates with the aperture 62 of the latch bolt 46 in the present invention.

The base 100 generally includes a mating assembly 104 that is designed to connect to the balance channel 72 of the block and tackle balance assembly 70. In one preferred embodiment, the mating assembly 104 is dimensioned to fit within the balance channel 72. It is understood that the mating assembly 104 could connect to the balance channel 72 in other configurations including fitting along an outside surface or distal end surface of the balance channel 72. As further shown in FIGS. 2-10, the mating assembly 104 includes two vertical walls 106,108 that are connected by a first, or lower crossbar 110 and a second, or upper crossbar 112. The vertical walls 106,108 include a first set of openings 114, holes or apertures. The vertical walls 106,108 also have a second set of openings 116, holes or apertures. As further shown, the vertical walls 106,108 have an offset portion to define a flange 118 on each vertical wall 106,108. The lower crossbar 110 has a ridge 120 extending along a central portion of the lower crossbar 110. The structure of the base 100 cooperatively defines a pulley mount 122 to be described in greater detail below. The base 100 further has an open bottom configuration that defines a passageway.

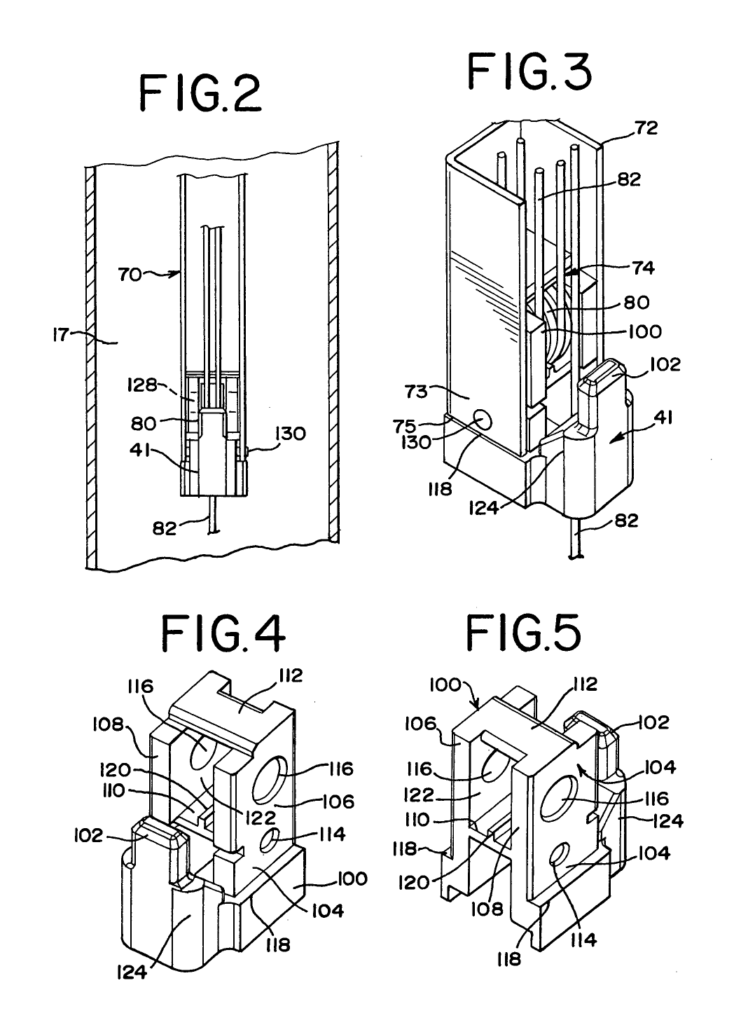

As further shown in FIGS. 3-10, the projection 102 is a member that extends substantially vertically to cooperate with the latch bolt 46. In one preferred embodiment, the projection 102 has a generally rectangular cross-section. The projection 102 may generally be dimensioned to fit within the aperture 62 of the latch bolt 46. The projection 102 may also have rounded peripheral edges. A space may be maintained between the projection 102 and an inner surface defining the aperture of the latch bolt 46. The projection 102 is connected to the base 100 by a leg 124. The leg 124 extends between a bottom portion of the base 100 and the projection 102. The leg 124 thus spaces the projection 102 from the base 100. The leg 124 is configured to maintain the open bottom configuration of the base 100. The leg 124 supports the projection 102 in generally a vertical configuration. In a preferred embodiment, the base 100, leg 124 and the projection 102 are integrally formed and can be made from an injection-molding process.

As shown in FIGS. 1-3, 19-20, the retainer 41 is operably connected to the balance assembly 15. As discussed, in a preferred embodiment, the retainer 41 is uniquely incorporated into the block and tackle balance assembly 70. The mating assembly 104 fits within the balance channel 72. The pulley mount 122 defined by the mating assembly 104 receives the first set of pulleys 80 of the block and tackle mechanism 74. The pulleys 80 have openings that align with the second set of openings 116. A support shaft 128 (FIG. 2) is received through the second set of openings 116 and through the pulleys 80 and support the pulleys 80. The distal edge 75 of the balance channel 72 abuts the flanges 118 defined on the vertical walls 104,106 (FIG. 3). This configuration provides a stop limit for insertion of the retainer 41 into the balance channel 72. The openings 73 on the balance channel 72 align with the first set of openings 114. A rivet 130, or other suitable fastener, extends through the aligned openings 73,114 to secure the retainer 41 to the balance channel 72 and, therefore, the block and tackle balance assembly 70 (FIGS. 2-3). In addition, it is understood that the cord 82 passes through the open bottom configuration of the base 100 of the retainer 41. The ridge 120 projects towards the pulleys 80 and helps assure that the cord 82 passing around the pulleys 80 does not jump or come disengaged from the pulleys 80. Thus, it is understood that the structure of the retainer 41 and its connection to the balance channel 72 allows the balance assembly 15 to function as normal.

Once the retainer 41 is connected to the balance channel 72, the balance assembly 15 is connected to the sash window assembly 11. As shown in FIG. 1, the balance channel 72 is suitably mounted within the shoe channel 17. The balance channel 72 is positioned in the shoe channel 17 such that the retainer 41 will be properly positioned to cooperatively engage the latch bolt 46, which may be considered to be generally a midpoint of the guide rails 16.

In use, and as can be appreciated from FIGS. 19 and 20, the sash window 12 is slidable within the master frame 14 between a closed position wherein the sash window 12 is fully lowered and an open position wherein the sash 12 is raised from the closed position. As the sash window 12 slides within the master frame 14, the distal end 60 of the latch bolt 46 extends into the shoe channel 17. When the sash window 12 is moved from an open position to a closed position, the aperture 62 of the distal end 60 receives the projection 102. That is, a portion of the projection 102 extends through the aperture 62, although there need not necessarily be any contact between the projection 102 or any other portion of the retainer 41 and the latch bolt 46. Therefore, when the sash 12 is in its closed position, the distal end 60 of the latch bolt 46 and the retainer 41 are in an interference relationship with one another. More specifically, the retainer 41 will resist any lateral movement of the latch bolt 46 that may result from excessive wind conditions or from any object that may forcefully strike the window sash 12. This resists or prevents unwanted pivoting or disengagement of the sash window 12 from the master frame 14.

It should be noted that in other respects the tilt-latch assembly 10 functions in a similar manner as many of the known tilt-latches. That is, when the sash 12 slides within the master frame 14, the distal end 60 of the latch bolt 46 extends into the guide rail 16 to maintain the sash 12 within the master frame 14, in a vertical, un-pivoted configuration. To tilt the sash 12 out of the master frame 14, the latch bolt 46 is moved to its retracted position by use of the actuator 48 thereby removing the distal end 60 from the guide rail 16, to allow the sash 12 to tilt. It is understood that the sash window 12 will be raised slightly such that latch bolt 46 clears the projection 102. Thus, the aperture 62 no longer receives the projection 102. While being raised, the sash window 12 may still be considered to be in the closed position. The vertical length of the projection 102 could vary, thus varying the amount that the sash window 12 must be raised for the latch bolt 46 to clear the projection 102. Of course, there is preferably an identical tilt-latch assembly 10 located at each upper corner of the sash window 12, both of which would need to be so manipulated to permit tilting.

FIG. 21 shows a slight variation of the cooperative structure between the retainer 41 and the latch bolt 46. It is understood that the retainer 41, suitably connected to the block and tackle balance assembly 70, can be provided with an aperture 150. In such configuration, the latch bolt 46 may be provided with a projection 152 that preferably depends downwardly from the latch bolt 46. The projection 152 on the latch bolt 46 is received by the aperture 150 on the retainer 41 connected to the balance assembly 15,70.

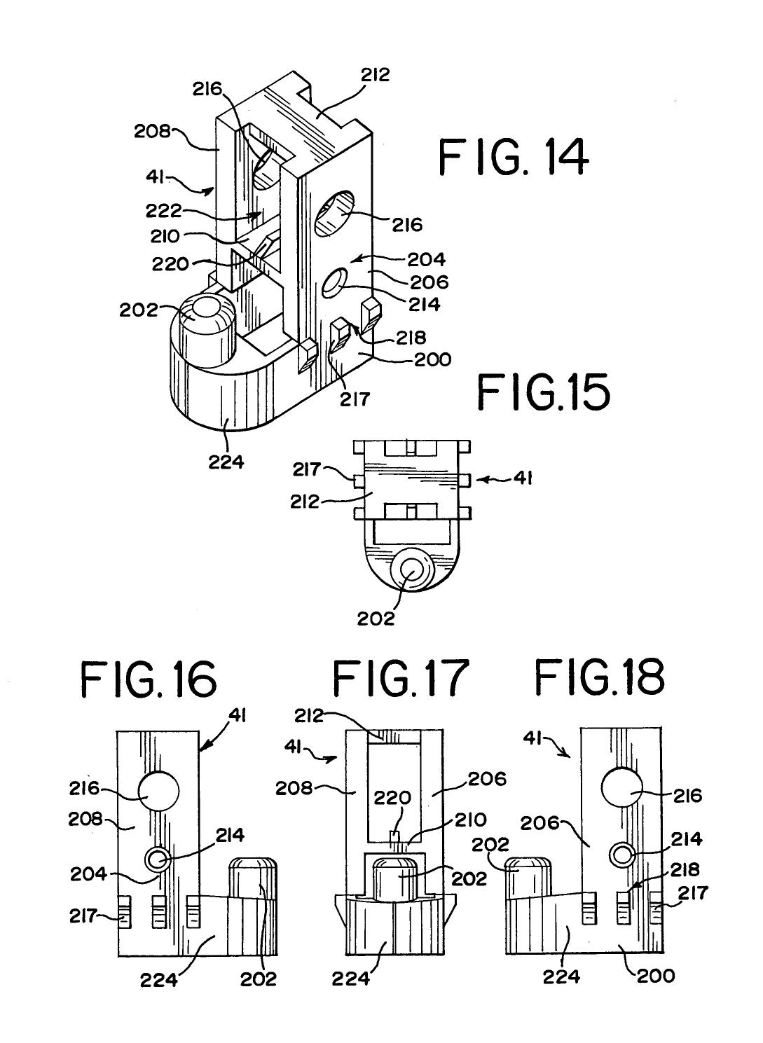

FIGS. 14-18 show another embodiment of the retainer 41. The retainer 41 of this embodiment is substantially similar to the retainer 41 of the previous embodiment. Similar elements are referred to using a 200 series reference numeral designation.

As further shown in FIGS. 14-18, the retainer 41 generally includes a base 200 and a projection 202 extending from the base 100. As discussed, the projection 202 of the retainer 41 forms a portion of the cooperative structure. In particular, the projection 202, while being operably connected to the balance assembly 15, cooperates with the structure of the latch bolt 46 in the present invention

The base 200 generally includes a mating assembly 204 that is designed to connect to the balance channel 72 of the block and tackle balance assembly 70. In one preferred embodiment, the mating assembly 204 is dimensioned to fit within the balance channel 72. It is understood that the mating assembly 204 could connect to the balance channel 72 in other configurations including fitting along an outside surface or distal end surface of the balance channel 72. As further shown in FIGS. 14-18, the mating assembly 204 includes two vertical walls 206,208 that are connected by a first, or lower crossbar 210 and a second, or upper crossbar 212. The vertical walls 206,208 include a first set of openings 214, holes or apertures. The vertical walls 206,208 also have a second set of openings 216, holes or apertures. As further shown, the vertical walls 206,208 have a plurality of extending protrusions 217 that cooperatively define a flange 218 on each vertical wall 206,208. The lower crossbar 210 has a ridge 220 extending along a central portion of the lower crossbar 210. The structure of the base 200 cooperatively define a pulley mount 222 to be described in greater detail below. The base 200 further has an open bottom configuration that defines a passageway.

As further shown in FIGS. 14-18, the projection 202 is a member that extends substantially vertically to cooperate with the latch bolt 46. In one preferred embodiment, the projection 202 is rounded and has a generally circular cross-section. The projection 202 may generally be dimensioned to fit within the aperture of the latch bolt 46. The projection 202 may also have rounded peripheral edges. A space may be maintained between the projection 202 and an inner surface defining the aperture of the latch bolt 46. The projection 202 is connected to the base 200 by a leg 224. The leg 224 extends between a bottom portion of the base 200 and the projection 202. The leg 224 thus spaces the projection 202 from the base 200. The leg 224 is configured to maintain the open bottom configuration of the base 200. The leg 224 supports the projection 202 in generally a vertical configuration. In a preferred embodiment, the base 200, leg 224 and the projection 202 are integrally formed and can be made from an injection-molding process.

As shown in FIGS. 1-3, 19-20, the retainer 41 is operably connected to the balance assembly 15 in the same fashion as discussed above. In a preferred embodiment, the retainer 41 is uniquely incorporated into the block and tackle balance assembly 70. The mating assembly 204 fits within the balance channel 72. The other connections described above apply equally to the embodiment of the retainer 41 of FIGS. 14-18. It is also understood that the structure of the retainer 41 and its connection to the balance channel 72 allows the balance assembly 15 to function as normal. As in the other embodiments, the projection 202 and latch bolt aperture 62 of this embodiment contain a structure for cooperatively engaging. Therefore, the aperture 62 of the latch bolt 46 in this embodiment is preferable round. When the sash window is in its closed position, the projection 202 is received by the aperture 62.

It is understood that the latch bolt 46 and the block and tackle balance assembly 70 have cooperative structure to enhance the support of the sash window 12 within the master frame 14. It is further understood that the retainer 41 could be an integral tab or projection that is connected to and extends directly from the balance channel 72 or some other part of the block and tackle balance assembly 70.

The tilt-latch assembly 10 provides many benefits. Sash window assemblies are subject to forces when under high wind loads such as from severe thunderstorms, tropical storms, and hurricanes. The cooperative positional relationship between the latch bolt aperture 62 and the projection 102 provides resistance to such wind loads. It is understood that the dimensions of the aperture and projection could be modified as desired to provide full surface-to-surface contact or to vary the clearances between the projection 102 and an interior surface of the latch bolt as defined by the aperture 62. By incorporating the cooperative structure with the balance assembly 15, and in particular, the block and tackle balance assembly 70, additional components are not necessary for the sash window assembly 11.

While the specific embodiments have been illustrated and described, numerous modifications come to mind without significantly departing from the spirit of the invention, and the scope of protection is only limited by the scope of the accompanying claims.

What is claimed is:

1. A tilt-latch assembly for use with a window assembly having a sash window slidable within a master frame between a pair of guide rails, each guide rail forming a shoe channel, the sash window assembly further having a balance assembly positioned within the shoe channel and operably connected between the master frame and the sash window, the sash window having an open position and a closed position, the tilt-latch assembly comprising:
a retainer adapted to be operably connected to the balance assembly; and,
a tilt-latch adapted to be supported by the sash window, the tilt-latch having a latch bolt with a distal end, the latch bolt slidable between an extended position and a retracted position,
wherein the retainer and latch bolt have cooperative structure such that the retainer engages the latch bolt when the latch bolt is in the extended position and the sash window is in the closed position.

2. The tilt-latch assembly of claim 1 wherein the retainer has a base adapted to be connected to the balance assembly, wherein the cooperative structure comprises a projection extending from the base and an aperture in the distal end of the latch bolt wherein the aperture receives the projection when the latch bolt is in the extended position and the sash window is in the closed position.

3. The tilt-latch assembly of claim 2 wherein the projection is connected to the base by a leg wherein the projection is spaced from the base.

4. The tilt-latch assembly of claim 2 wherein the projection has a generally rectangular cross-section.

5. The tilt-latch assembly of claim 1 wherein the cooperative structure comprises an aperture in the retainer and a projection extending from the distal end of the latch bolt wherein the aperture receives the projection when the latch bolt is in the extended position and the sash window is in the closed position.

6. The tilt-latch of claim 1 wherein the cooperative structure comprises one of the retainer and latch bolt having a projection and the other of the retainer and the latch bolt having an aperture, wherein the aperture receives the projection when the latch bolt is in the extended position and the sash window is in the closed position.

7. A tilt-latch assembly for use with a window assembly having a sash window slidable within a master frame between a pair of guide rails, each guide rail forming a shoe channel, the sash window having an open position and a closed position, the tilt-latch assembly comprising:
a balance assembly adapted to be operably connected between the shoe channel and the sash window;
a retainer connected to the balance assembly; and,
a tilt-latch adapted to be supported by the sash window, the tilt-latch having a latch bolt with a distal end, the latch bolt slidable between an extended position and a retracted position, the distal end having an aperture,
wherein the aperture receives the retainer when the latch bolt is in the extended position and the sash window is in the closed position.

8. The tilt-latch assembly of claim 7 wherein the balance assembly is a block and tackle balance assembly.

9. The tilt-latch assembly of claim 8 wherein the block and tackle balance assembly has a balance channel, the balance channel adapted to be connected to the shoe channel, the retainer connected to the balance channel.

10. The tilt-latch assembly of claim 9 wherein the retainer has a base, the base positioned within the balance channel.

11. The tilt-latch assembly of claim 10 wherein the block and tackle balance assembly has a pulley assembly and the base defines a pulley mount, the pulley mount receiving and supporting the pulley assembly.

12. The tilt-latch assembly of claim 11 wherein the pulley assembly comprises a pair of pulleys and the base has a rib positioned generally between the pair of pulleys.

13. The tilt-latch assembly of claim 7 wherein the retainer has a base and projection extending from the base, the base being connected to the balance assembly and wherein the aperture receives the projection when the latch bolt is in the extended position and the sash window is in the closed position.

14. The tilt-latch assembly of claim 10 wherein the balance channel and base have mating openings that receive a fastener that connects the base to the balance channel.

15. The tilt-latch assembly of claim 10 wherein the block and tackle balance assembly has a cord having a first end connected to the balance channel and a second end adapted to be connected to the sash window, the base having defining a passageway wherein the cord extends through the passageway.

16. The tilt-latch assembly of claim 7 wherein the retainer has a base connected to the balance assembly, the base having a projection that is received by the aperture.

17. The tilt-latch assembly of claim 16 wherein the aperture is larger than the projection wherein a space is maintained between a surface of the projection and a surface of the tilt-latch defining the aperture when the aperture receives the projection.

18. The tilt-latch assembly of claim 16 wherein the projection is generally rectangular.

19. The tilt-latch assembly of claim 16 wherein the aperture is generally circular.

20. A tilt-latch assembly for use with a window assembly having a sash window slidable within a master frame between a pair of guide rails, each guide rail forming a shoe channel, the sash window having an open position and a closed position, the tilt-latch assembly comprising:
a block and tackle balance assembly adapted to be positioned within the shoe channel and adapted to be operably connected between the master frame and the sash window, the block and tackle balance assembly having a balance channel supporting a pair of pulleys;
a retainer having a base and a projection extending from the base, the base defining a pulley mount, the base connected to the balance channel wherein the pulley mount receives the pair of pulleys and wherein the projection is spaced from the balance channel; and,
a tilt-latch adapted to be supported by the sash window, the tilt-latch having a latch bolt with a distal end, the latch bolt slidable between an extended position and a retracted position, the distal end having an aperture,
wherein the aperture receives the projection when the latch bolt is in the extended position and the sash window is in the closed position.

21. A block and tackle balance assembly comprising:
a balance channel;
a pair of pulleys connected to the balance channel;
a retainer having a base and projection extending from the base, the base defining a pulley mount, the base connected to the balance channel wherein the pulley mount receives the pair of pulleys, the projection being spaced from the balance channel.

22. A block and tackle balance assembly for use with a window assembly having a sash window slidable within a master frame between a pair of guide rails, each guide rail forming a shoe channel, the window assembly further having a tilt-latch mounted on the sash window, the tilt-latch having a latch bolt having a distal end, the block and tackle balance assembly comprising:
a balance channel adapted to be positioned within the shoe channel;
a retainer connected to the balance channel, the retainer having cooperative structure thereon, the cooperative structure adapted to cooperate with the distal end of the aperture.

23. The block and tackle balance assembly of claim 22 wherein the cooperative structure is a projection extending from retainer, the projection adapted to be received by an aperture in the distal end of the latch bolt.

24. A retainer for use with a sash window assembly having a sash window slidable within a master frame between a pair of guide rails, each guide rail forming a shoe channel having a block and tackle balance assembly positioned therein, the sash window further having a tilt-latch having a latch bolt, the retainer comprising:
a base configured to connect with the block and tackle balance assembly; and
a projection extending from the base, wherein the projection is configured to cooperate with the latch bolt.

25. The retainer of claim 24 wherein the projection is connected to the base by a leg.

26. The retainer of claim 24 wherein the base has a pair of vertical walls connected by a cross-bar.

27. The retainer of claim 26 wherein the cross-bar has a ridge thereon.

28. The retainer of claim 26 wherein the vertical walls each have an offset portion defining a flange.

29. The retainer of claim 24 wherein the projection has a generally rectangular cross-section.

30. A sash window assembly comprising:
a master frame having a guide rail forming a channel;
a sash window slidable along the guide rail, the sash window having an open position and a closed position;
a block and tackle balance assembly connected to the channel and being operably connected to the sash window, the balance assembly having a balance channel;
a retainer having a base and a projection extending from the base, the base connected to the balance channel wherein the projection is spaced from the balance channel; and
a tilt-latch having a housing supported by the sash window, the tilt-latch further having a latch bolt slidably supported by the housing between an extended position and a retracted position, the latch bolt having a distal end having an aperture,
wherein the aperture receives the projection when the latch bolt is in the extended position and the sash window is in the closed position.
